(19) United States
(12) Patent Application Publication
(10) Pub. No.: US 2023/0222895 A1
(43) Pub. Date: Jul. 13, 2023

(54) SYSTEM AND METHOD FOR CONTROLLING SMART DEVICES WITH A REMOTE CONTROLLER

(71) Applicant: VESTEL ELEKTRONIK SANAYI VE TICARET A.S., Manisa (TR)

(72) Inventors: Murat CANDAN, Manisa (TR); Onur AKDEMIR, Manisa (TR)

(73) Assignee: VESTEL ELEKTRONIK SANAYI VE TICARET A.S., Manisa (TR)

(21) Appl. No.: 18/009,275

(22) PCT Filed: Jun. 8, 2020
(86) PCT No.: PCT/EP2020/065791

§ 371 Date: Dec. 8, 2022

(51) Int. Cl. G08C 17/02; G06F 3/033; G06T 7/20; G08C 23/04

(52) U.S. Cl. CPC G08C 17/02; G06F 3/033; G06T 7/20; G08C 23/04

(57) ABSTRACT

The present disclosure relates to a system (100) comprises a smartboard (10) and a remote controller (20), wherein the smartboard (10) comprises a frame structure (11), wherein a plurality of transmitters (111) and receivers (112) is arranged at the frame structure (11) and configured to transmit and receive radio signals (40) within a plane defined by the frame structure (11); and wherein the smartboard (10) further comprises a controller unit (12) coupled to at least one of the one or more of the plurality of transmitters (111) and receivers (112). The remote controller (20) is configured to provide a radio control signal (30) to the frame structure (11) and the controller unit (12) is configured to control the smartboard (10) based on a detection that the at least one of the one or more of the plurality of transmitters (111) and receivers (112) has received the radio control signal (30).

### FIELD

Embodiments of the present disclosure relate to a system comprising a smartboard and a remote controller and to a method for controlling such system.

### BACKGROUND

Some smartboards are formed by interactive, digital whiteboards. They can be connected to a computer and/or a beamer and can be controlled with a remote controller. An infrared receiver module is typically provided to receive the infrared light emitted by the remote controller to control such device.

The infrared receiver module is located in the front area of the device or externally installed as a separate module. Due to the position of the receiver module, detection problems may occur which reduce the controllability of such devices. Further, the production of such receiver modules is costly in different stages of the production of the smart device, such as craftsmanship, assembly, stock, material supply, design and cost up for the manufacturer. On top of that, these modules increase the power consumption of the smartboard and result in additional costs.

Smartboards are often used in teaching and fulfill the following two main features. The first one is to be written on, and the second one to be used like a computer screen which every student can see. When the boards are connected to a computer and a beamer, the computer screen can be projected on the smartboard by the beamer. Using the remote controller the smartboards can be turned on and off, one can switch between the “writing”-mode and the “computer-screen”-mode, and when in the “computer-screen”-mode, one can control settings such as volume when watching a video or enter a password by pressing buttons on the remote controller. Especially in this context, the quick and efficient functionality of the system is relevant for a continuous lesson. More information about an exemplarily smartboard according to the prior art is described at https://downloadcenter. samsung. com/content/UM/201708/20170811103554754/DME-BR_65-75-82_DME-BM_82_EU_WebManual_Eng-04_20170616.0.pdf.

In view of the above, new systems that allow for controlling smartboards with a remote controller and methods for controlling smartboards with a remote controller, that overcome at least some of the problems in the art, are beneficial.

### SUMMARY

In light of the above, a system comprising a smartboard and a remote controller, as well as a method for controlling such system are provided.

It is an object of the present disclosure to provide an improved system and method for controlling a smartboard with a remote controller.

Further objects, aspects, benefits, and features of the present disclosure are apparent from the claims, the description, and the accompanying drawings.

According to an independent aspect of the present disclosure, a system, comprising a smartboard and a remote controller for controlling the smartboard is presented. The smartboard comprises a frame structure, wherein a plurality of transmitters and receivers is arranged at the frame structure and configured to transmit and receive radio signals within a plane defined by the frame structure; and a controller unit coupled to at least one of the one or more of the plurality of transmitters and receivers: the remote controller is configured to provide a radio control signal to the frame structure; and wherein the controller unit is configured to control the smartboard based on a detection that the at least one of the one or more of the plurality of transmitters and receivers has received the radio control signal.

According to a further independent aspect of the present disclosure, a method for controlling a system, the system comprising a smartboard and a remote controller for controlling the smartboard, wherein the smartboard comprises a frame structure, wherein a plurality of transmitters and receivers is arranged at the frame structure and configured to transmit and receive radio signals within a plane defined by the frame structure; and a controller unit coupled to at least one of the one or more of the plurality of transmitters and receivers; the method comprising providing, by the remote controller, a radio control signal to the frame structure; and controlling, by the controller unit, the smartboard based on a detection that the at least one of the one or more of the plurality of transmitters and receivers has received the radio control signal, is provided.

Embodiments are also directed at devices for carrying out the disclosed methods and include system parts for performing each described method aspect. These method aspects may be performed by way of hardware components, a computer programmed by appropriate software, by any combination of the two or in any other manner. Furthermore, embodiments according to the disclosure are also directed at methods for operating the described system. The methods include method aspects for carrying out every function of the system for controlling a smartboard with a remote controller.

### BRIEF DESCRIPTION OF THE DRAWINGS

So that the manner of the above recited features of the present disclosure can be understood in detail, a more particular description of the disclosure, briefly summarized above, may be made by reference to embodiments. The accompanying drawings relate to embodiments of the disclosure and are described in the following:

FIG. 1: shows a schematic view of the system for controlling a smartboard with a remote controller according to embodiments described herein;

FIG. 2: shows a schematic view of the frame structure according to the embodiments described herein;

FIG. 3: illustrates a method for controlling a smartboard with a remote controller and especially the schematic function of the controller unit according to the embodiments described herein;

FIG. 4A and 4B: shows a schematic view of the system including a camera and the function of the camera according to the embodiments described herein; and

FIG. 5: shows a schematic view of the frame structure and the function of the application according to the embodiments described herein.

FIG. 6: shows a schematic view of the gyro sensor and the servo motor according to the embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to the same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Common smartboards can be controlled with a remote controller. These remote controllers often work based on the IR standard. Smartboards have an externally installed module that corresponds to the IR signals transmitted by the remote controller to execute the command that is given via the remote controller. This external module is only able to receive the IR signals transmitted by the remote controller if the remote controller is pointed at the module in a certain angle, thus a rapid and effective use of smartboards not possible. Moreover, these externally installed modules result in extra cost in production and use, thereby diminishing the attractiveness of the use of smartboards.

The embodiments of the present disclosure overcome the above drawbacks by providing a system with a plurality of transmitters and receivers such that the remote controller can be pointed anywhere at the screen of the smartboard and the signals transmitted by the remote controller are recognized wherever the remote controller is pointed, without the need for an externally installed module. Thereby a rapid and effective response and use of the smartboard is guaranteed and costs are reduced.

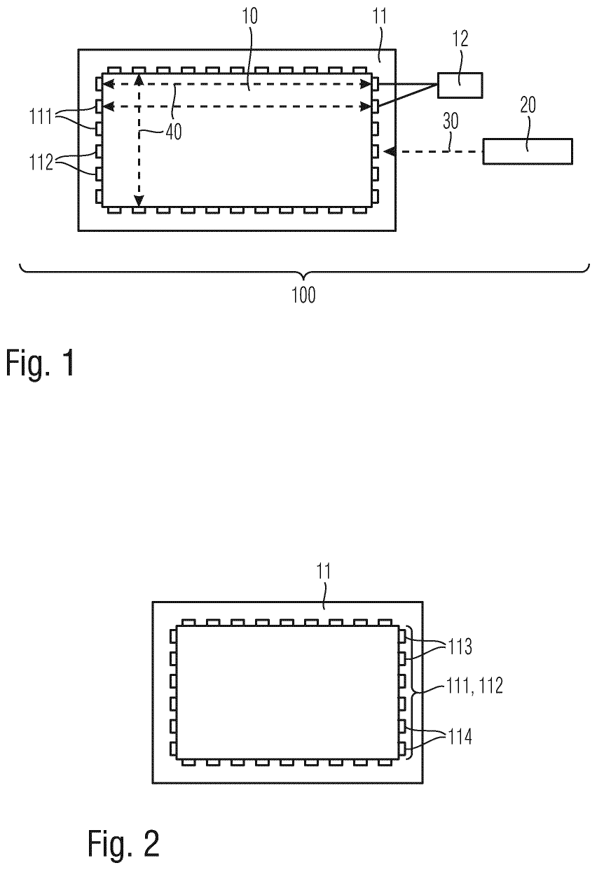

FIG. 1 shows a schematic view of a system 100 for controlling a smartboard with a remote controller according to the embodiments described herein.

The system 100 comprises a smartboard 10 and a remote controller 20, wherein the smartboard 10 comprises a frame structure 11, wherein a plurality of transmitters 111 and receivers 112 is arranged at the frame structure 11 and configured to transmit and receive radio signals 40 within a plane defined by the frame structure 11; and wherein the smartboard 10 further comprises a controller unit 12 coupled to at least one of the one or more of the plurality of transmitters 111 and receivers 112. The remote controller 20 is configured to provide a radio control signal 30 to the frame structure 11 and the controller unit 12 is configured to control the smartboard 10 based on a detection that the at least one of the one or more of the plurality of transmitters 111 and receivers 112 has received the radio control signal 30.

The remote controller 20 provides a radio control signal 30 to the receivers 111 in the frame structure 11. This structural element may be rectangular, round or elliptic. Controlling the smartboard 10 with a remote controller 20 implies fulfilling the common functions a remote controller 20 is used for such as turning on and off the smartboard.

FIG. 2 shows a schematic view of the frame structure 11. This structural element may be rectangular, round, elliptic or shaped in any shape that spans an area. The transmitters 111 and receivers 112 located at the frame structure 11 may be arranged at regular intervals or without a certain order.

Both the radio signals 40 that the transmitters 111 and receivers 112 at the frame structure 12 are configured to transmit and receive, and the radio control signal 30 provided by the remote controller 20 are for example compliant with the IR standard. These signals may also be compliant with radio wave signals, sound, ultrasonic sound, inductive transmission with a transmission frequency of about 10 kHz.

According to some embodiments of the present disclosure each of the at least one or more or all of the plurality of transmitters 111 may comprise one or more LEDs 113 configured to emit light and each of at least one or more or all of the plurality of receivers 112 may comprise one or more photodetectors 114 configured to receive the light emitted by the one or more LEDs 113. The number of LEDs 113 and photodetectors 114 may be equal or differ. The LEDs 113 and photodetectors 114 may be of different sizes such that one or more photodetectors 114 correspond to the light emitted by one LED 113 or vice versa. Further, the LEDs 113 may be arranged at one side of the frame and the photodetectors 114 on the opposite side or they may be arranged alternately according to a certain pattern or randomly. The photodetectors 114 are arranged in a way such that they can project the light of the LEDs 113.

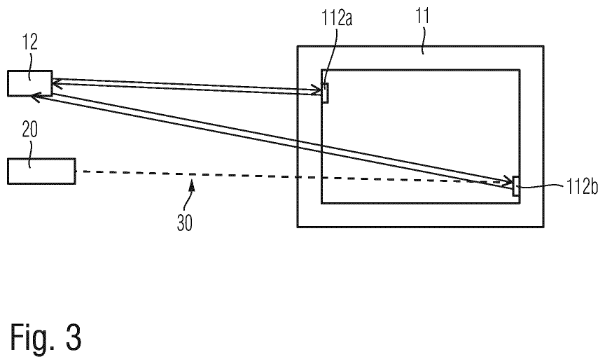

FIG. 3 illustrates a method for controlling a smartboard 10 with a remote controller 20 and especially the schematic function of the controller unit 12.

The system comprises the controller unit 12, wherein the controller unit 12 is configured to select one of the plurality of receivers 112 that has received the radio control signal 30 by determining a first receiver 112a of the plurality of receivers 112 and switching to a different receiver 112b of the plurality of receivers 112 depending a signal quality of the received radio control signal 30 at the first receiver 112a and the different receiver 112b, respectively. In order to do so, the controller unit 12 is coupled to several receivers 112.

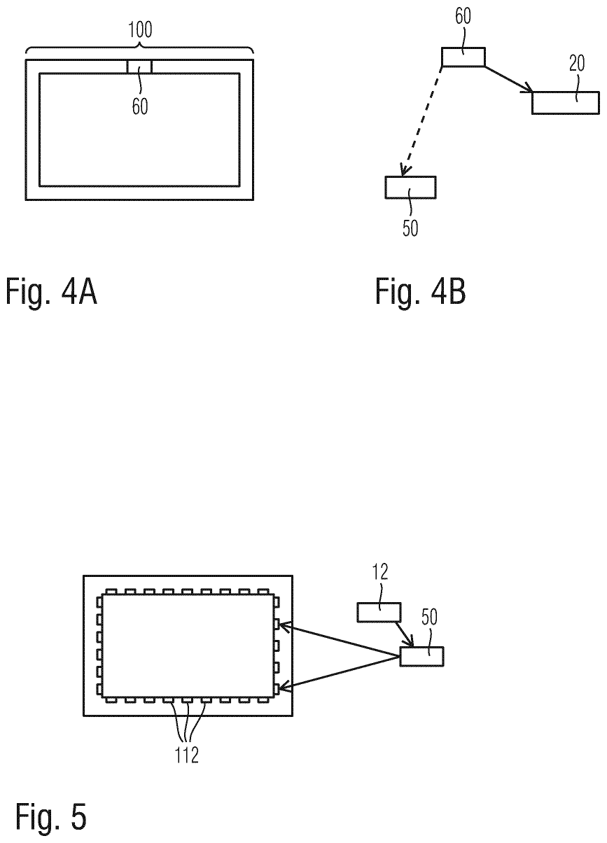

FIGS. 4A and 4B show a schematic view of the system 100 comprising a camera 60 and the function of the camera 60 according to the embodiments described herein.

In some embodiments of the present disclosure, the system 100 includes a camera 60 at the frame structure 11, wherein the camera 60 is configured to locate the remote controller 20 and to track the remote controller 20. In particular, the camera 60 may also be a wide angle camera. In another example it may also be a video recorder. The camera 60 is said to be at the frame structure 11. Alternatively, it may be installed externally at the smartboard 10. The tracking of the remote controller 20 may be fulfilled by using an object tracking algorithm. In another example, the camera 60 may be programmed to follow a GPS transmitter or a Ground Station Controller (GSC) that is installed at the remote controller 20. In yet another example, vision recognition technology may be used to track the remote controller 20.

According to another embodiment, the remote controller 20 may be located by an ultrasonic detector, a laser based detector and/or a radar detector.

FIG. 5 shows a schematic view of the frame structure 11 and the function of the application according to the embodiments described herein.

The system 100 further includes an application 50, wherein the application 50 is configured to separately control the receivers 112. The application 50 may be an extra module or may be installed as part of the controller unit 12. It is activated when the smartboard 10 is powered on by a software in the background. In another example the controller unit 12 is configured to perform the function of the application 50.

The camera 60 is configured to provide information indicative of the location of the remote controller 20 to the application 60 and/or controller unit 12. The transmission of the information may occur by means with or without a wire and the processor to process the information indicative of the location of the remote controller 20 may be part of the camera 60 or an external module.

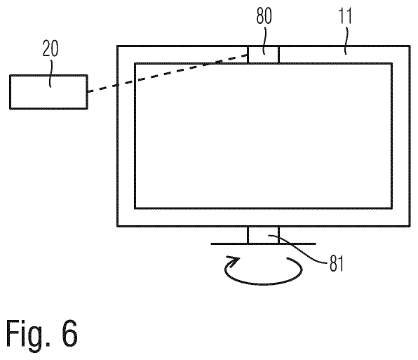

FIG. 6 shows a schematic view of the gyro sensor 80 and the servo motor 81 according to the embodiments described herein.

The system 100 may further comprise a gyro sensor 80 and a servo motor 81 configured to determine a relative position the smartboard 10 has with respect to the remote controller 20 and to orientate the smartboard 10 towards the remote controller 20. By this, the smartboard 10 is always positioned such that the receivers 112 and transmitters 111 at the frame structure 11 are in view with the radio control signal 30 transmitted by the remote controller 20. This function may replace the function of the camera 60 or may assist the camera 60.

The present disclosure comprises a method for controlling a system 100 comprising a smartboard 10 and a remote controller 20 for controlling the smartboard 10, wherein the smartboard 10 comprises a frame structure 11 wherein a plurality of transmitters 111 and receivers 112 is arranged at the frame structure 11 and configured to transmit and receive radio signals 40 within a plane defined by the frame structure 11. The method further comprises a controller unit 12 coupled to at least one of the one or more of the plurality of transmitters 111 and receivers 112. The remote controller 20 is configured to provide a radio control signal 30 to the frame structure 11. The method comprises detecting the radio control signal 30 by the at least one of the one or more of the plurality of transmitters 111 and receivers 112 and controlling the smartboard 10 by the controller unit 12 based on the detection.

1. A system (100), comprising a smartboard (10) and a remote controller (20) for controlling the smartboard (10), wherein:
the smartboard (10) comprises
a frame structure (11), wherein a plurality of transmitters (111) and receivers (112) is arranged at the frame structure (11) and configured to transmit and receive radio signals (40) within a plane defined by the frame structure (11); and
a controller unit (12) coupled to at least one of the one or more of the plurality of transmitters (111) and receivers (112);
the remote controller (20) is configured to provide a radio control signal (30) to the frame structure (11); and wherein
the controller unit (12) is configured to control the smartboard (10) based on a detection that the at least one of the one or more of the plurality of transmitters (111) and receivers (112) has received the radio control signal (30).

2. The system (100) of claim 1, wherein both the radio signals (40) and the radio control signal (30) are compliant with the IR standard.

3. The system (100) of claim 1 or 2, wherein each of the at least one or more or all of the plurality of transmitters (111) comprises one or more LEDs (113) configured to emit light.

4. The system (100) of claim 3, wherein each of the at least one or more or all of the plurality of receivers (112) comprises one or more photodetectors (114) configured to receive the light emitted by the one or more LEDs (113).

5. The system (100) of one of the preceding claims, wherein the controller unit (12) is configured to select one of the plurality of the receivers (112) that has received the radio control signal (30) by determining a first receiver (112a) of the plurality of receivers (112) and switching to a different receiver (112b) of the plurality of receivers depending a signal quality of the received radio control signal (30) at the first receiver (112a) and the different receiver (112b), respectively.

6. The system (100) of one of the preceding claims, including an application (50), wherein the application (50) is configured to separately control the receivers (112). The system (100) of claim 6, wherein the controller unit (12) is configured to perform the function of the application (50).

8. The system (100) of one of the preceding claims, comprising a camera (60) at the frame structure (11), wherein the camera is configured to locate the remote controller (20).

9. The system (100) of claim 8, wherein the camera (60) is configured to track the remote controller (20).

10. The system (100) of claim 8 or 9, wherein the camera (60) is configured to provide information indicative of the location of the remote controller (20) to the application (50) and/or the controller unit (12).

11. The system (100) of one of the preceding claims, further comprising
a gyro sensor (80) for determining a relative position the smartboard (10) has with respect to the remote controller (20) and
a servo motor (81) configured to orientate the smartboard (10) towards the remote controller (20).

12. The system (100) of one of the preceding claims, comprising an ultrasonic detector, laser based detector and/or radar detector configured to locate the remote controller (20).

13. A method for controlling a system (100), the system comprising a smartboard (10) and a remote controller (20) for controlling the smartboard (10), wherein:
the smartboard (10) comprises
a frame structure (11), wherein a plurality of transmitters (111) and receivers (112) is arranged at the frame structure (11) and configured to transmit and receive radio signals (40) within a plane defined by the frame structure (11); and
a controller unit (12) coupled to at least one of the one or more of the plurality of transmitters (111) and receivers (112);
the method comprising
providing, by the remote controller (20), a radio control signal (30) to the frame structure (11); and
controlling, by the controller unit (12), the smartboard (10) based on a detection that the at least one of the one or more of the plurality of transmitters (111) and receivers (112) has received the radio control signal (30).
